(19) United States
(12) Patent Application Publication
(10) Pub. No.: US 2007/0256975 A1
(43) Pub. Date: Nov. 8, 2007

(54) Selective reaction method for isolating metallic nitride fullerenes using amine chemistry

(76) Inventor: Steven A. Stevenson, Hattiesburg, MS (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/418,810

(22) Filed: May 5, 2006

(51) Int. Cl. C02F 1/42

(52) U.S. Cl. 210/638

(57) ABSTRACT

The present invention is directed to a novel method for isolating fullerenes. In a preferred embodiment, the process purifies metallic nitride fullerenes from non-metallic nitride fullerenes by mixing a solution containing metallic nitride fullerenes with a functionalized silica gel, allowing the mixture to react for an amount of time effective to immobilize non-metallic nitride fullerenes on said gel, and filtering the silica gel to obtain a filtrate containing purified metallic nitride fullerenes separated from other more abundant fullerenes like empty cage fullerenes and classical metallofullerenes. The mixture of fullerenes is added to the silica gel and stirred and filtered, thus separating the fullerenes/silica gel (top of filter) from the filtrate (bottom solution) containing only MNFs. In another embodiment, the process purifies C₆₀ empty cage fullerenes from other empty cage fullerenes with a functionalized silica gel by mixing a solution containing C₆₀ and other empty cage fullerenes with a functionalized silica gel, allowing the mixture to react for an amount of time effective to immobilize the non-C₆₀ fullerenes on said gel, and filtering the silica gel to obtain a filtrate containing purified C₆₀ fullerene separated from other empty cage. This newly developed “Stir and Filter Approach” (SAFA) technique permits purified fullerene samples at ambient or reflux conditions.

### FIELD OF THE INVENTION

The invention relates to the field of isolating chemical compounds and, more specifically, to the isolation of fullerenes. In particular, selective reaction methods for isolating metallic nitride fullerenes from empty cage fullerenes and classical metallofullerenes are disclosed.

### BACKGROUND OF THE INVENTION

Fullerenes are a family of closed-caged molecules made up of carbon atoms. The closed-caged molecules consist of a series of five and six member carbon rings. The fullerene molecules can contain 60 or more carbon atoms. The most common fullerene is the spherical C60 molecule taking on the familiar shape of a soccer ball.

Fullerenes are typically produced by an arc discharge method using a carbon rod as one or both of the electrodes in a Krätschmer-Huffman generator. Krätschmer, W. et al., Chem. Phys. Lett., 170, 167-170 (1990) herein incorporated by reference in its entirety. Typically the generator has a reaction chamber and two electrodes. The reaction chamber is evacuated and an inert gas is introduced in the reaction chamber at a controlled pressure. A potential is applied between the electrodes in the chamber to produce an arc discharge. The arc discharge forms a carbon plasma in which fullerenes of various sizes are produced.

Many derivatives of fullerenes have been prepared including encapsulating metals inside the fullerene cage. Metal encapsulated fullerenes are typically prepared by packing a cored graphite rod with the metal oxide of the metal to be encapsulated in the fullerene cage. The packed graphite rod is placed in the generator and arc discharged to produce fullerene products. The formation of metal encapsulated fullerenes is a complicated process and typically yields only very small amounts of the metal fullerenes.

The emergence of recently discovered (1) metallic nitride fullerenes (MNFs) now provides multidisciplinary opportunities to investigate their fundamental properties and pursue their application development. Synthesis of trimetallic nitride endohedral metallofullerenes according to U.S. Pat. No. 6,303,760 is incorporated by reference herein in its entirety. Synthesized using the trimetallic nitride template (TNT) electric-arc process, (2) MNFs consist structurally of a trigonal planar (1) or slightly pyramidalized (3) cluster of atoms encapsulated within a fullerene cage housing, which receives significant charge transfer from the entrapped metals. (4-8) The judicious selection of rare-earth and/or transition metals affords a rich array of interests to the scientific community. Emerging applications of metal-encapsulated fullerenes include their development as new medical agents. (9-14)

Separation difficulties have led to a paucity of isolated MNFs. Separation techniques designed to remove contaminant empty-cage fullerenes (e.g. C₆₀, C₇₀ . . . C₂ₙ) and classical metallofullerenes (e.g. Mₓ@C₂ₙ) from MNFs (e.g. Sc₃N@C₈₀) traditionally require expensive and tedious chromatographic equipment. Traditional HPLC separation methods (1) for MNFs are unfavorable due to expense (e.g. equipment, solvent waste, and columns), poor throughput (e.g. low solubility of MNFs in typical mobile phases), and the presence of a wide array of fullerene contaminants co-extracted from electric-arc soot. The C₆₀ and C₇₀ fullerenes dominate the soluble product distribution with minor amounts of higher cage fullerenes such as C₇₈, C₈₂, C₈₄, C₈₆, C₈₈, C₉₀ . . . C₂ₙ (n>39) and classical metallofullerenes (Aₘ@C₂ₙ, A=metal, m=1-4) that also must be removed. Recent advances in MNF separation science include the use of cyclopentadiene immobilized on an insoluble resin (Merrifield) as a flash chromatography medium for room temperature MNF separations. (15) Although the Merrifield resin (18) approach permits a rapid isolation of MNFs (15) (1 day) and represents an improvement over HPLC, the cyclopentadienyl-Merrifield resin method is expensive and requires solvent flow. The use of selective electrochemical methods has also recently been described as a purification approach for classical metallofullerenes (16) and MNFs. (17)

In view of the foregoing, it would be an advancement in the art to provide a lower cost method to isolate and purify MNFs and C₆₀ that is non-chromatographic and would require no flowing solvents. Such a method is disclosed and claimed herein.

### BRIEF SUMMARY OF THE INVENTION

The present invention is directed to a method for isolating and purifying fullerenes. The method uses functionalized silica gels to selectively react with fullerenes. In a preferred embodiment, the invention provides a process for isolating metallic nitride fullerenes from non-metallic nitride fullerenes comprising: mixing a solution containing metallic nitride fullerenes with a functionalized silica gel; allowing the mixture to react for an amount of time effective to immobilize non-metallic nitride fullerenes on said gel; and filtering said silica gel to obtain a filtrate containing purified metallic nitride fullerenes. This approach can be described as a “stir and filter approach” (SAFA), whereby fullerenes are added to a slurry of reactive silica gel, stirred, and filtered. Under appropriate conditions, substantially pure MNFs or C₆₀ would be obtained in the filtrate. In SAFA, fullerene contaminants are bound to the solid support and trapped by the filter membrane.

In one embodiment, the process is performed under reflux conditions. In another embodiment, the process is performed at room temperature. In one embodiment, the functionalized silica gel is an aminofunctionalized silica gel. In another embodiment, the aminofunctionalized silica gel can be a diamino, monoamino, or triamino silica gel. In another embodiment, the functionalized silica gel is a cyclopentadienyl silica gel. In another embodiment, the aminofunctionalized silica gel is any amino substituted silica gel. Solvents that can solubilize fullerenes, such as carbon disulfide, toluene, xylene, trichlorobenzene, or dichlorobenzene can be used. Other solvents that can be used include alkanes, cycloalkanes, haloalkanes, thiophenes, and aromatic organics.

In another embodiment, SAFA purifies C₆₀ empty cage fullerenes from other empty cage fullerenes with a functionalized silica gel by mixing a solution containing C₆₀ and other empty cage fullerenes with the functionalized silica gel, allowing the mixture to react for an amount of time effective to immobilize the non-C₆₀ fullerenes on said gel, and filtering the silica gel to obtain a filtrate containing purified C₆₀ fullerene separated from other empty cage fullerenes.

### BRIEF DESCRIPTION OF THE DRAWINGS

FIG. 1 depicts the % MNF purity obtained from ambient temperature Stir and Filter Approach with triamino, diamino, monoamino, cyclopentadienyl and n-propyl functionalized silica gels.

FIG. 2 depicts the uptake of fullerenes at various reaction times using cyclopentadienyl functionalized silica gel under reflux conditions.

### DETAILED DESCRIPTION OF THE INVENTION

The present invention is directed to a novel method for isolating fullerenes. Substantially pure MNFs or C₆₀ can be obtained by the method. Substantially pure is greater than 97% purity. More particularly, substantially pure is greater than 98% purity. In a preferred embodiment, the method involves aminosilane materials bonded to silica gels to create amino-based silica gels which can then be used to immobilize non-metallic nitride fullerenes on the gel and isolate MNFs. The mixture of fullerenes is added to the silica gel and stirred. The solid/liquid slurry is then filtered, thus separating the fullerenes/silica gel (top of filter) from the filtrate (bottom solution) containing only MNFs. The amino-based silica gel can also be used with a mixture of empty cage fullerenes to immobilize non-C₆₀ fullerenes on the gel and isolate C₆₀.

In one embodiment, the isolation is conducted under reflux conditions to simulate soot extraction conditions where electric-arc soot is extracted under reflux conditions with hot solvent continuously flowing over a bed of soot.

In another embodiment, the isolation is performed at room or ambient temperature. Surprisingly, the aminofunctionalized silica gels at room or ambient temperature “stir and filter” works better than under reflux conditions.

In one embodiment, the solvent used in the method is toluene. In another embodiment, the solvent is any solvent that solubilizes the fullerenes, for example, carbon disulfide, xylene, trichlorobenzene, or dichlorobenzene. Aromatic organics such as benzene and other benzene derivatives can also be used in the method, for example, xylenes, mesitylene, tetralin, bromobenzene, anisole, and chlorobenzene. Other solvents that can be used include cycloalkanes, for example, decalin, cis-decalin, and trans-decalin and substituted alkanes, for example, haloalkanes such as dichloromethane, chloroform, dibromoethane, trichloroethylene, tetrachloroethylene, and tetrahalo alkanes such as 1,1,2,2-tetrachloroethane. Thiophenes, for example, 2-methylthiophene, pyridine, and pyrollidone can also be used. Naphthalenes such as 1-methylnaphthalene, dimethylnaphthalenes, phenylnaphthalene, chloronaphthalene are other solvents that can be used in the method.

The amino functionalized gel can include any appropriate amine group. Examples of useful amine groups include monamino, diamino, triamino, cyclopentadienyl and other amines with more amino groups or amino groups at different spacing intervals. Schemes 3-5 depicted in below are amino functionalized gels that can be used in the present invention, including monoamino (3), diamino (4) and triamino (5) materials. Scheme (2) is a cyclopentadienyl functionalized gel that can be used in the present invention. Scheme (1) is a n-propyl functionalized silica gel to use as a control in experiments. Not shown are other amines with more amino groups or amino groups at different spacing intervals (locations).

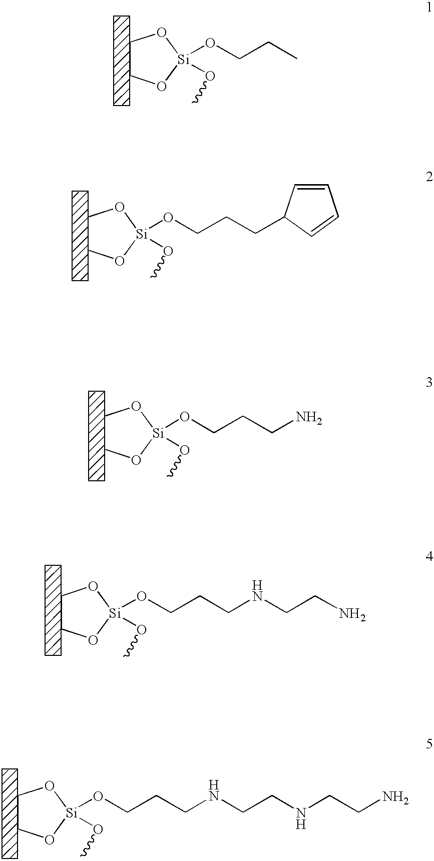

The use of aminosilanes (26-28) as a coupling agent to silica gel has previously been demonstrated. Aminosilanes have been used in the preparation of polypyrrole-silica particles, (29) dendrons, (30) and amino-functionalized silica gels. (26) Applications of amine derivatized silica gels include their use as a stationary phase in liquid and gas chromatography, (31, 32) their ability to separate and concentrate trace metals, (33, 34) and as an active site to bind other molecules. (35, 36) MNF separation schemes include cyclopentadiene (CPD) immobilized on Merrifield resin for room temperature flash chromatography. (15) To add to this body of work, we have prepared cyclopentadienyl (2), monoamino (3), diamino (4) and triamino (5) silica gels for use in MNF separations using SAFA. As a control, we prepared n-propyl silica (1).

### EXAMPLES

### Control: Synthesis of n-Propyl-Functionalized Silica Gel 1

A 5-L round bottom flask was filled with toluene, charged with 250 g silica gel and distilled under nitrogen to ca. 4000 mL azeotropically to remove water. To this flask was added 75 g of n-propyltrimethoxysilane (Gelest) over a 20 minute period, and the reaction was stopped after 6 hours. The solid product was rinsed with toluene, chloroform, methanol, chloroform, and hexane and vacuum dried at 60° C. for 1 day (260 g) and stored in a dessicator. Elemental analysis indicates 3.80% C and 1.15% H. Using carbon data, an estimate of 1.1 mmol/g (45 mg/g) is calculated using the C₃H₇ (43 g/mol) moiety as the functional group. A surface coverage of 2.1 μmol/m² is estimated based on 500 m²/g of surface coverage for unfunctionalized silica (Aldrich).

### Example 1

### Synthesis of a Cyclopentadienyl-Functionalized Silica Gel 2

A 2-L round bottom flask was filled with toluene, charged with 100 g silica gel and refluxed under nitrogen to ca. 1500 mL of toluene for the azeotropic removal of water. To this flask was added 25 g of 3-cyclopentadienylpropyltriethoxysliane over a 20 minute period, and the reaction was stopped after 6 hours. The solid product was rinsed with toluene, chloroform, methanol, chloroform, and hexane. The silica gel product was vacuum dried (107.82 g) at 60° C. for 3 days and stored in a dessicator. Elemental analysis indicates 3.87% C, 1.12% H, and 0.0% N. Using carbon data, an estimate of 0.41 mmol/g (43 mg/g) is calculated using the C₈H₁₁ (107 g/mol) moiety as the functional group. A surface coverage of 0.81 μmol/m² is estimated based on 500 m²/g of surface coverage for unfunctionalized silica (Aldrich).

### Example 2

### Synthesis of Monoamino-Functionalized Silica Gel 3

A 2-L round bottom flask was filled with toluene, charged with 80 g silica gel and refluxed under nitrogen to ca. 1500 mL of toluene for the azeotropic removal of water. To this flask was added 20 g of 3-aminopropyltriethoxysilane over a 20 minute period, and the reaction was stopped after 6 hours. The solid product was rinsed with toluene, chloroform, methanol, chloroform, and hexane. The silica gel product was vacuum dried (86.5 g) at 60° C. for 3 days and stored in a dessicator. Elemental analysis indicates 4.38% C, 1.10% H, and 1.34% N. Using carbon data, an estimate of 1.2 mmol/g (71 mg/g) is calculated using the C₃H₈N (58 g/mol) moiety as the functional group. A surface coverage of 2.4 μmol/m² is estimated based on 500 m²/g of surface coverage for unfunctionalized silica (Aldrich).

### Example 3

### Synthesis of a Diamino-Functionalized Silica Gel 4

A 2-L round bottom flask was filled with toluene, charged with 100 g silica gel and refluxed under nitrogen to ca. 1500 mL of toluene for the azeotropic removal of water. To this flask was added 25 g of N-(2-aminoethyl)-3-aminopropyltriethoxysilane over a 20 minute period, and the reaction was stopped after 6 hours. The solid product was rinsed with toluene, chloroform, methanol, chloroform, and hexane. The silica gel product was vacuum dried (105.1 g) at 60° C. for 3 days and stored in a dessicator. Elemental analysis indicates 5.33% C, 1.46% H, and 1.97% N. Using carbon data, an estimate of 0.88 mmol/g (89 mg/g) is calculated using the C₅H₁₃N₂ (101 g/mol) moiety as the functional group. A surface coverage of 1.8 μmol/m² is estimated based on 500 m²/g of surface coverage for unfunctionalized silica (Aldrich).

### Example 4

### Synthesis of Triamino Functionalized Silica Gel 5

A 5-L round bottom flask was filled with toluene, charged with 250 g silica gel and distilled under nitrogen to ca. 4000 mL azeotropically to remove water. To this flask was added 70 g of (3-trimethoxysilylpropyl)diethylene triamine (Gelest) over a 20 minute period, and the reaction was stopped after 6 hours. The solid product was rinsed with toluene, chloroform, methanol, chloroform, and hexane and vacuum dried at 60° C. for 1 day (282 g) and stored in a dessicator. Elemental analysis indicates 8.16% C, 1.92% H, and 3.47% N. Using carbon data, an estimate of 0.97 mmol/g (140 mg/g) is calculated using the C₇H₁₈N₃, (144 g/mol) moiety as the functional group. A surface coverage of 1.9 μmol/m² is estimated based on 500 m²/g of surface coverage for unfunctionalized silica (Aldrich).

### Example 5

### Room Temperature Isolation of MNFs from Soot Extract

Scandium fullerene soot from the electric-arc reactor was extracted with o-xylene and dried under rotary evaporation. A soot extract stock solution was prepared at a ratio of 80 mg extract per 100 mL toluene. For room temperature experiments, a 50 mL round bottom flask was charged with 13 g of this stock solution and 3 g of functionalized silica. This slurry was stirred for arbitrary reaction times. The reaction mixture was then filtered through a PTFE membrane filter (0.50 μm) until no color was observed. The sample volume was then adjusted to the initial mass of solution (13 g) for HPLC analysis.

As a control experiment to demonstrate the lack of fullerene uptake by non-reactive silica, 13 g of extract solution was mixed with n-propyl silica (3 g). The control silica gel had 6.1% functional group loading. The slurry was stirred under ambient temperature for 1, 9, 22, 31, and 42 hours. MNF purity of the solution was 5% at time zero, and increased to only 7% at 42 hours. HPLC analysis of the product mixture at 42 hours indicated a 98% recovery of MNF. The 2% loss of MNF is likely due to adsorption to silica gel.

To investigate fullerene uptake by a reactive silica gel, 13 g of extract solution was mixed with cyclopentadienyl (CPD) functionalized silica (3 g). The CPD silica gel had 6.3% functional group loading. After 20 hours of stirring, the MNF purity increased slightly from 5% to 12%.

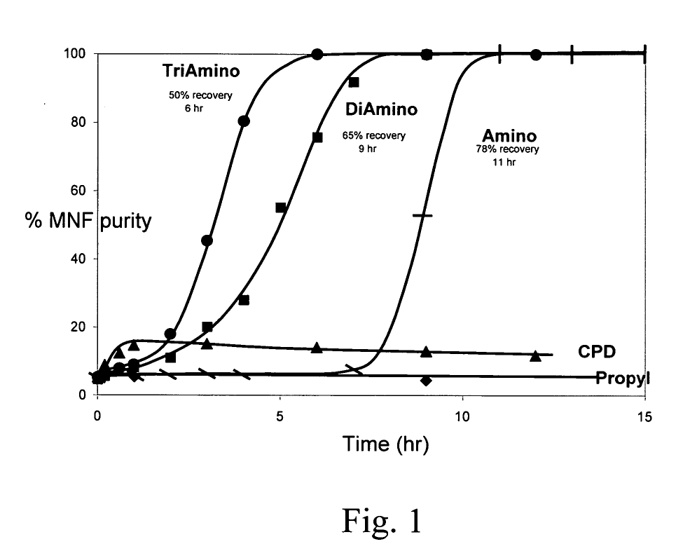

To explore a different class of reactive silica, SAFA experiments were designed with alkyl substituted, amino functional groups. The monoamino (3), diamino (4), and triamino (5) silica gels had percent functional group loading onto the silica gels of 8.5%, 12%, and 14% respectively. Substantially purified MNFs can be obtained with all three amino-functionalized silica gels tested. (FIG. 1) Table 1 details MNF purity over time using the SAFA at room temperature. Monoamino silica at 11 hours exhibited substantially pure MNFs with 78% recovery. Substantially pure MNFs were obtained with Diamino silica in 9 hours with 84% recovery. Analysis for triamino silica resulted in substantially pure MNFs at only 6 hours of reaction time but with 50% recovery. CPD silica at ambient temperature SAFA fails to give substantially pure MNFs. To demonstrate fullerene purity, a mass spectrum of purified Sc₃N@C₈₀ MNF obtained by SAFA was performed.

TABLE 1
MNF purity over time of functionalized silica
gels using SAFA at Ambient Temperature

| MonoAmino | | DiAmino | | TriAmino | | CPD | | n-propyl | |
|---|---|---|---|---|---|---|---|---|---|
| Time | % | Time | % | Time | % | Time | % | Time | % |
| (hr) | purity | (hr) | purity | (hr) | purity | (hr) | purity | (hr) | purity |
| 0 | 5 | 0 | 5 | 0 | 5 | 0 | 5 | 0 | 5 |
| 1 | 5 | 0.2 | 6 | 0.2 | 6 | 0.2 | 9 | 1 | 4 |
| 2 | 5 | 1 | 8 | 0.6 | 8 | 0.6 | 12 | 9 | 4 |
| 3 | 6 | 2 | 11 | 1 | 9 | 1 | 15 | 22 | 5 |
| 4 | 5 | 3 | 20 | 2 | 17 | 3 | 15 | 31 | 6 |
| 7 | 7 | 4 | 28 | 3 | 44 | 6 | 14 | 42 | 7 |
| 9 | 53 | 5 | 55 | 4 | 63 | 9 | 13 | | |
| 11 | 100 | 6 | 76 | 6 | 100 | 12 | 12 | | |
| 13 | 100 | 7 | 92 | 9 | 100 | 20 | 12 | | |
| | | 9 | 100 | 12 | 100 | | | | |

### Example 6

### Reflux Temperature Isolation of MNFs from Soot Extracts with Functionalized Silica Gels

As fullerene soot extracts are often obtained under refluxing aromatic solvents, the efficacy of SAFA experiments with CPD (2), monamino (3), and diamino (4) gels at the boiling point of toluene was investigated to determine whether the functionalized silicas could be used successfully with SAFA under different experimental parameters. Unfunctionalized silica was used as a control.

Scandium fullerene soot from the electric-arc reactor was extracted with o-xylene and dried under rotary evaporation. A soot extract stock solution was prepared at a ratio of 80 mg extract per 100 mL toluene. Two 500 mL round bottom flasks, each with a vertical condenser, were charged with 100 mL of soot extract standard solution, 5.0 g of a silica gel sample, and stirred under nitrogen for 2 days. Upon filtration through a PTFE membrane filter (0.50 μm), 100 mL of each filtrate was then placed in each of two empty round bottom flasks, 5.0 fresh grams of a silica gel sample was added to each flask, stirred under nitrogen at reflux, and at the end of 2 days, this process was repeated for each 2-day increment for a maximum of 8 days. Two parallel reactions were done for duplicate analyses. Table 2 summarizes the results of the data. The data indicates reduction of C₆₀, C₇₀, and Sc₃N@C₈₀ MNF by factors of 2.6, 2.2, 2.5, respectively, and with a lack of selectivity for unfunctionalized silica gel. Under reflux of the same Sc fullerene extract with monoamino silica gel for eight days, there is remarkable selectivity. The C₆₀ fullerene has been reduced by a factor of 111, with no other empty-cage fullerene compounds observed at the detection limits of HPLC. In contrast, the Sc₃N@C₈₀ MNF has been reduced only by a factor of 3.3.

TABLE 2
Summary of Silica Gel Reactivity Data Under Reflux

| | Unfunctionalized | | | | | | | | | Cyclopentadienyl | | |
|---|---|---|---|---|---|---|---|---|---|---|---|---|
| | Silica | | | MonoAmino Silica | | | DiAmino Silica | | | Silica | | |
| Time | C₆₀ | C₇₀ | MNF | C₆₀ | C₇₀ | MNF | C₆₀ | C₇₀ | MNF | C₆₀ | C₇₀ | MNF |
| (Days) | (μM) | (μM) | (μM) | (μM) | (μM) | (μM) | (μM) | (μM) | (μM) | (μM) | (μM) | (μM) |
| 0 | 49 | 18 | 2.5 | 49 | 18 | 2.5 | 49 | 18 | 2.5 | 49 | 18 | 2.5 |
| 2 | 33 | 13 | 2.1 | 25 | 7.9 | 1.6 | 5.4 | 1.7 | 1.5 | 0.56 | 1.8 | 1.8 |
| 4 | 25 | 10 | 1.3 | 8.1 | 1.9 | 1.4 | 1.5 | 0.19 | 1.3 | 0 | 0 | 0.6 |
| 6 | 20 | 8.7 | 1.1 | 3.3 | 0.68 | 1.2 | 0 | 0 | 0.47 | | | |
| 8 | 19 | 8.1 | 1.0 | 0.44 | 0 | 0.75 | | | | | | |

### Example 7

### Uptake-Time Study of Fullerenes with Cyclopentadienyl Silica

To evaluate optimal reaction times, an experiment was designed to vary time. From the soot extract standard solution prepared above in Example 5, 15 mL of this stock solution was placed in each of five 50 mL round bottom flasks (14/20). To each flask was added 3.04 g of cyclopentadienyl silica gel. The flasks were heated to reflux, while stirring in a nitrogen atmosphere. The cyclopentadienyl functionalized silica gel reactions with C₆₀ and C₇₀ were performed under toluene reflux, followed by room temperature filtration, and HPLC analysis. Samples were analyzed at time intervals of 1, 9, 20, 30, and 41 hours.

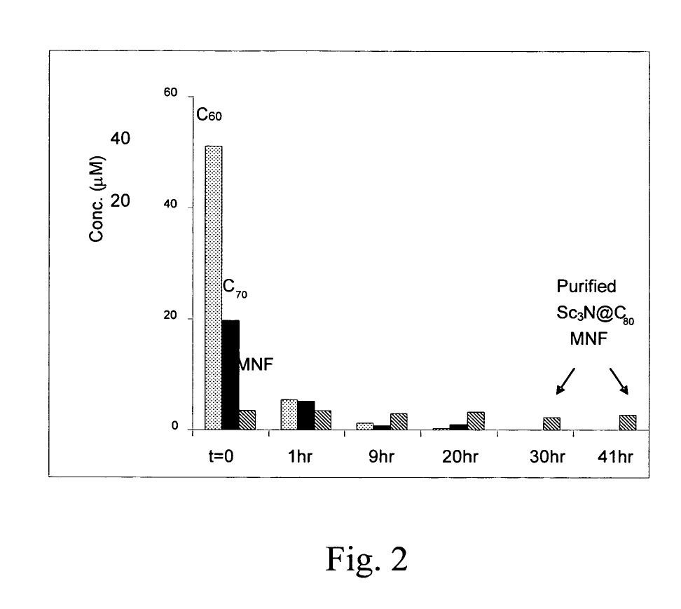

Filtrations were performed using 0.50 μm membrane filters, and filtrates were subsequently characterized by HPLC and MALDI-TOF mass spectrometry. Mass spectral and HPLC data indicate C₆₀, C₇₀ as well as other fullerenes (e.g. C₇₆, C₇₈, C₈₄ . . . . ) and classical metallofullerenes (e.g. Sc₂@C₈₂, Sc₂@C₈₄ . . . . ) react and are removed with the cyclopentadienyl functionalized silica gel. FIG. 2 shows the uptake of fullerenes at various reaction times using the cyclopentadienyl functionalized silica gel. Specific results indicate factors of 10 and 4 for removal of C₆₀ and C₇₀, respectively, in only 1 hour. After 9 hours, the concentrations of C₆₀ and C₇₀ are almost equal, and further reaction time (20 hours) results in more unreacted C₇₀ (1.3 μM) than C₆₀ (0.8 μM). This reactivity preference of C₆₀ versus C₇₀ for cyclopentadienyl silica gel is in contrast to the amino- and diamino-based silica gels. To assess MNF purity, aliquots of filtrates from 30 and 41 hours were analyzed by mass spectrometry. Each sample indicates only MNFs are present at these reaction times. When compared to the 8% Sc₃N@C₈₀ MNF present in the initial MNF Sc fullerene extract solution, the purified sample after 41 hours of reaction time is 98+% Sc₃N@C₈₀ MNF with only a trace of residual Sc₃N@C₇₈ MNF.

### Example 8

### Effect of Cyclopentadienyl Silica Loading on Sc₃N@C₆₈, Sc₃N@C₇₈, and Sc₃N@C₈₀ MNFs.

From the soot extract standard solution from Example 7, 15 mL was placed in each of five 50 mL round bottom flasks (14/20). To each flask was added a stir bar and an arbitrary quantity (0.38 g, 0.76 g, 1.52 g, and 2.28 g, and 3.04 g) of cyclopentadiene functionalized silica gel. Samples were stirred and refluxed under nitrogen for 41 hours, cooled, and filtered through a 0.50 μm membrane filter. The filtrate was then analyzed by HPLC and MALDI-TOF mass spectrometry. Loading of 15 wt % of CPD functionalized silica gel at reflux for 41 hours resulted in a filtrate containing only the MNF series of Sc₃N@C₆₈, Sc₃N@C₇₈, and Sc₃N@C₈₀. A slight increase to 20 wt % of CPD functionalized silica gel, also at 41 hours, resulted in removal of Sc₃N@C₆₈ and a further reduction of Sc₃N@C₇₈ for an overall sample of 98%+ purified sample of Sc₃N@C₈₀. Lower silica loading experiments with 3, 6, and 11 weight percent for the CPD silica gel for 41 hours of reaction indicated residual empty-cage fullerene contaminants.

### Example 9

### Room Temperature Stir and Filter Approach to Isolate C₆₀ from Higher Fullerenes

The Stir and Filter Approach method can also be used to isolate C₆₀ from higher empty cage fullerenes such as C₇₀, C₇₆, C₇₈, C₈₂, C₈₄, etc. A stock solution of empty-cage fullerene extract was made using solid graphite rods in the electric arc synthesis process. 50 mg of the empty-cage fullerene extract in 25 mL of o-xylene was stirred with diamino silica gel at ambient temperature. Aliquots were removed and filtered at various times to analyze the purity of the C₆₀. Table 3 summarizes the results of the data. A 96% pure C₆₀ (trace of C₇₀) can be obtained with almost 60% recovery, based on the amount of C₆₀ in the starting extract. A 99% pure sample of C₆₀ can be obtained with approximately 40% recovery.

TABLE 3
Purification of C60 species with diamino
silica using SAFA at ambient temperatures

| Time | | | Higher fullerenes | % purity |
|---|---|---|---|---|
| (hr) | C60 | C70 | (C76, C78, C82, C84, etc) | C60 |
| 0 | 331 | 130 | 28 | 68 |
| 2 | 206 | 23 | 0 | 90 |
| 4 | 189 | 8.9 | 0 | 96 |
| 8 | 122 | 1.6 | 0 | 99 |
| 18 | 30 | 0.27 | 0 | 99 |
| 24 | 8.7 | 0.13 | 0 | 99 |
| 28 | 3.6 | 0 | 0 | 100 |

A new “stir and filter approach” (SAFA) for isolating MNF samples is disclosed. Using the SAFA process, purified Sc₃N@C₈₀ MNFs (98+%) are obtained at room temperature using triamino, diamino and monoamino functionalized silica. Under elevated temperatures MNFs were successfully isolated using SAFA with CPD (41 hr, 80% recovery). In comparison, the diamino silica gel still permits isolation of purified MNFs, but with longer reaction times compared to the CPD gel. As expected, the monoamino silica gel is the worst performing of the functionalized silica gels evaluated under reflux conditions for isolating metallic nitride fullerenes. Aminofunctionalized silica gels such as diamino silica gel yield substantially pure C60 from a mixture of empty cage fullerenes using the SAFA process. Advantages of the SAFA process for MNF purification are as follows: (1) no chromatography equipment, columns, fraction collectors, (2) no flowing solvent reduces cost and disposal, “green chemistry” (3) rapid separation time of 6 hours (4) no electrochemical equipment, (5) room temperature separations, (6) separations under aerobic conditions, (7) inexpensive chemicals to make functionalized silica, (8) unattended separation, and a (9) scalable process for industry. Also of significance is the ability to “tune” the selection of MNFs as a function of silica loading. One can achieve a sample containing all three MNF cages of 68, 78, and 80 atoms or increase the loading amount to obtain the Sc₃N@C₈₀ species.

### REFERENCES

1. Stevenson, S.; Rice, G.; Glass, T.; Harich, K.; Cromer, F.; Jordan, M. R.; Craft, J.; Hadju, E.; Bible, R.; Olmstead, M. M.; Maitra, K.; Fisher, A. J.; Balch, A. L.; Dorn, H. C. Nature 1999, 401, 55-57.
2. Kratschmer, W.; Lamb, L. D.; Fostiropoulos, K.; Huffman, D. R. Nature 1990, 347, 354-358.
3. Stevenson, S.; Phillips, J. P.; Reid, J. E.; Olmstead, M. M.; Rath, S. P.; Balch, A. L. Chemical Communications 2004, 2814-2815.
4. Aihara, J. Physical Chemistry Chemical Physics 2001, 3, 1427-1431.
5. Kobayashi, K.; Sano, Y.; Nagase, S. Journal Of Computational Chemistry 2001, 22, 1353-1358.
6. Larade, B.; Taylor, J.; Zheng, Q. R.; Mehrez, H.; Pomorski, P.; Guo, H. Physical Review B 2001, 64, 195402.
7. Campanera, J. M.; Bo, C.; Olmstead, M. M.; Balch, A. L.; Poblet, J. M. Journal Of Physical Chemistry A 2002, 106, 12356-12364.
8. Campanera, J. M.; Heggie, M. I.; Taylor, R. Journal Of Physical Chemistry B 2005, 109, 4024-4031.
9. Kato, H.; Kanazawa, Y.; Okumura, M.; Taninaka, A.; Yokawa, T.; Shinohara, H. Journal Of The American Chemical Society 2003, 125, 4391-4397.
10. Mikawa, M.; Kato, H.; Okumura, M.; Narazaki, M.; Kanazawa, Y.; Miwa, N.; Shinohara, H. Bioconjugate Chemistry 2001, 12, 510-514.
11. Shu, C. Y.; Gan, L. H.; Wang, C. R.; Pei, X. L.; Han, H. B. Carbon 2006, 44, 496-500.
12. Toth, E.; Bolskar, R. D.; Borel, A.; Gonzalez, G.; Helm, L.; Merbach, A. E.; Sitharaman, B.; Wilson, L. J. Journal Of The American Chemical Society 2005, 127, 799-805.
13. Wilson, L. J.; Cagle, D. W.; Thrash, T. P.; Kennel, S. J.; Mirzadeh, S.; Alford, J. M.; Ehrhardt, G. J. Coordination Chemistry Reviews 1999, 192, 199-207.
14. Bolskar, R. D.; Benedetto, A. F.; Husebo, L. O.; Price, R. E.; Jackson, E. F.; Wallace, S.; Wilson, L. J.; Alford, J. M. Journal Of The American Chemical Society 2003, 125, 5471-5478.
15. Ge, Z. X.; Duchamp, J. C.; Cai, T.; Gibson, H. W.; Dorn, H. C. Journal Of The American Chemical Society 2005, 127, 16292-16298.
16. Tsuchiya, T.; Wakahara, T.; Shirakura, S.; Maeda, Y.; Akasaka, T.; Kobayashi, K.; Nagase, S.; Kato, T.; Kadish, K. M. Chemistry Of Materials 2004, 16, 4343-4346.
17. Elliott, B.; Yu, L.; Echegoyen, L. Journal Of The American Chemical Society 2005, 127, 10885-10888.
18. Merrifield, R. B. Journal Of The American Chemical Society 1963, 85, 2149-2154.
19. Hirsch, A., The Chemistry of Fullerenes. Georg Thieme Verlag, Stuttgart: N.Y., 1994; p 73-80.
20. Taylor, R., Lecture Notes on Fullerene Chemistry. Imperial College Press: London, 1999; p 80-90.
21. Geckeler, K. E.; Hirsch, A., Polymer-Bound C-60. Journal Of The American Chemical Society 1993, 115, (9), 3850-3851.
22. Seshadri, R.; Govindaraj, A.; Nagarajan, R.; Pradeep, T.; Rao, C. N. R., Addition Of Amines And Halogens To Fullerenes C-60 And C-70. Tetrahedron Letters 1992, 33, (15), 2069-2070.
23. Seshadri, R.; Rao, C. N. R.; Pal, H.; Mukherjee, T.; Mittal, J. P., Interaction Of C-60 And C-70 With Aromatic-Amines In The Ground And Excited-States—Evidence For Fullerene Benzene Interaction In The Ground-State. Chemical Physics Letters 1993, 205, (4-5), 395-398.
24. Chen, K. M.; Caldwell, W. B.; Mirkin, C. A., Fullerene Self-Assembly Onto (MeO)3Si(CH2)3NH2-Modified Oxide Surfaces. Journal Of The American Chemical Society 1993, 115, (3), 1193-1194.
25. Caldwell, W. B.; Chen, K.; Mirkin, C. A.; Babinec, S. J., Self-Assembled Monolayer Films Of C(60) On Cysteamine-Modified Gold. Langmuir 1993, 9, (8), 1945-1947.
26. Vrancken, K. C.; Possemiers, K.; Vandervoort, P.; Vansant, E. F. Colloids And Surfaces A-Physicochemical And Engineering Aspects 1995, 98, 235-241.
27. Plueddemann, E. P., Silane Coupling Agents. 2nd ed.; Plenum Press: New York, 1991.
28. Plueddemann, E. P., Silane Compounds for Silylating Surfaces. In Silanes, Surfaces, and Interfaces, ed.; Leyden, D. E., Gordon and Breach Science Publishers: New York, 1986; Vol. 1, 1-24.
29. Perruchot, C.; Chehimi, M. M.; Delamar, M.; Lacaze, P. C.; Eccles, A. J.; Steele, T. A.; Mair, C. D. Synthetic Metals 1999, 102, 1194-1197.
30. Morikawa, A.; Kakimoto, M. A.; Imai, Y. Macromolecules 1992, 25, 3247-3253.
31. Porsch, B.; Kratka, J. Journal Of Chromatography 1991, 543, 1-7.
32. Smith, R. M., Gas and Liquid Chromatography in Analytical Chemistry. John Wiley and Sons: New York, 1988.
33. Leyden, D. E.; Luttrell, G. H. Analytical Chemistry 1975, 47, 1612-1617.
34. Taylor, I.; Howard, A. G. Analytica Chimica Acta 1993, 271, 77-82.
35. Cabral, J. M. S.; Kennedy, J. F., In Protein immobilization: Fundamentals and Applications, ed.; Taylor, R. F., Marcel Dekker: New York, 1991.
36. Kallury, K. M. R.; Thompson, M., In Chemically Modified Surfaces, ed.; Pesek, J. J.; Leigh, I. E., ‘Ed.’ˆ‘Eds.’ Royal Society of Chemistry: Cambridge, UK, 1994.
37. Guhr, K. I.; Greaves, M. D.; Rotello, V. M. Journal Of The American Chemical Society 1994, 116, 5997-5998.
38. Nie, B.; Rotello, V. M. Journal Of Organic Chemistry 1996, 61, 1870-1871.

We claim:

1. A process for purifying metallic nitride fullerenes from non-metallic nitride fullerenes comprising:
mixing a solution containing metallic nitride fullerenes with an amino-functionalized silica gel;
allowing the mixture to react for an amount of time effective to immobilize non-metallic nitride fullerenes on said gel; and
filtering said silica gel to obtain a filtrate containing purified metallic nitride fullerenes.

2. The process of claim 1 wherein the steps are conducted under reflux conditions.

3. The process of claim 1 wherein the steps are conducted at ambient temperature.

4. The process of claim 1 wherein the silica gel is a monoamino functionalized gel.

5. The process of claim 1 wherein the silica gel is a diamino functionalized gel.

6. The process of claim 1 wherein the silica gel is a triamino functionalized gel.

7. The process of claim 1 wherein the filtrate contains substantially pure metallic nitride fullerenes.

8. The process of claim 1 wherein the solution of metallic nitride fullerenes comprises toluene as a solvent.

9. The process of claim 1 wherein the solution of metallic nitride fullerenes comprises a solvent selected from the group of: toluene, carbon disulfide, xylene, trichlorobenzene, or dichlorobenzene.

10. The process of claim 1 wherein the solution of metallic nitride fullerenes comprises a solvent selected from the group of alkanes, cycloalkanes, haloalkanes, thiophenes, naphthalenes and aromatic organics.

11. A process for purifying metallic nitride fullerenes from non-metallic nitride fullerenes comprising:
mixing a solution containing metallic nitride fullerenes with a cyclopentadiene-functionalized silica gel;
allowing the mixture to react for an amount of time effective to immobilize non-metallic nitride fullerenes on said gel; and
filtering said silica gel to obtain a filtrate containing purified metallic nitride fullerenes.

12. The process of claim 11 wherein the steps are conducted under reflux conditions.

13. The process of claim 11 wherein the filtrate contains substantially pure metallic nitride fullerenes.

14. The process of claim 11 wherein the solution of metallic nitride fullerenes comprises toluene as a solvent.

15. The process of claim 11 wherein the solution of metallic nitride fullerenes comprises a solvent selected from the group of toluene, carbon disulfide, xylene, trichlorobenzene, or dichlorobenzene.

16. The process of claim 11 wherein the solution of metallic nitride fullerenes comprises a solvent selected from the group of alkanes, cycloalkanes, haloalkanes, thiophenes, naphthalenes, and aromatic organics.

17. A process for purifying C60 fullerene from a mixture of empty cage fullerenes comprising:
mixing a solution containing C60 fullerenes with an amino-functionalized silica gel;
allowing the mixture to react for an amount of time effective to immobilize non-C60 fullerenes on said gel; and
filtering said silica gel to obtain a filtrate containing purified C60.

18. The process of claim 17 wherein the steps are conducted at ambient temperature.

19. The process of claim 17 wherein the filtrate contains substantially pure C₆₀.

20. The process of claim 17 wherein the silica gel is a diamino functionalized gel.
